(19) United States
(12) Patent Application Publication
(10) Pub. No.: US 2023/0182595 A1
(43) Pub. Date: Jun. 15, 2023

(54) CHARGING STATION FOR AN ELECTRIC OR HYBRID VEHICLE

(71) Applicant: ads-tec Energy GmbH, Nürtingen (DE)

(72) Inventors: Thomas Speidel, Markgröningen (DE); Matthias Bohner, Stuttgart (DE); Raoul Heyne, Wiernsheim (DE)

(21) Appl. No.: 18/064,142

(22) Filed: Dec. 9, 2022

(30) Foreign Application Priority Data
Dec. 14, 2021 (DE) 10 2021 133 042.4

(51) Int. Cl. B60L 53/302; H02J 7/00

(52) U.S. Cl. CPC B60L 53/302; H02J 7/0042

(57) ABSTRACT

A charging station for an electric or hybrid vehicle includes at least one battery bank, a charging/discharging electronics system, at least one connection to a vehicle charging port, and an air conditioning device for heating and cooling at least one battery bank. The air conditioning device includes a refrigerant circuit for conducting a refrigerant and a coolant circuit for conducting a coolant. A control unit of the air conditioning device is configured for establishing a thermal short circuit of the coolant circuit between a heat reservoir and a cold reservoir and operating a motor of a compressor of the refrigerant circuit for as long as it takes for the waste heat of the motor fluidically connected to a space surrounding the battery bank to effectuate a temperature increase in the space to or above a predefined value.

### CROSS-REFERENCE TO RELATED APPLICATIONS

This application claims priority of German patent application No. 10 2021 133 042.4, filed Dec. 14, 2021, the entire content of which is incorporated herein by reference.

### TECHNICAL FIELD

The present disclosure relates to a charging station for an electric or hybrid vehicle, in particular a charging station that includes a device for air conditioning components of the charging station, and a method for controlling the air conditioning device.

### BACKGROUND

Batteries of electric and hybrid vehicles, in particular of so-called plug-in hybrids, the batteries of which can be charged with externally supplied electrical energy, preferably store a large amount of electrical energy, in order to enable a long electric driving range.

The charging stations must provide high charging power in order to be able to charge the batteries in a short time. While charging power of up to 100 kW can be achieved with, if necessary, three-phase AC current, higher charging power of up to 350 kW is presently achieved only by charging via direct current. In particular with respect to direct-current charging, battery banks can be used for locally storing the electrical energy and outputting the electrical energy to the vehicle to be charged, without the need for particularly complex connections to the grid.

During the charging and discharging of batteries of a battery bank, the batteries heat up due to the internal resistances and the chemical reactions. Since the cell voltages of the batteries and the maximum charging and discharging currents are temperature-dependent, an air conditioning of the battery bank is necessary, in particular, in extreme climates, in order to always be able to output the greatest possible charging power to vehicles to be charged and to not damage the batteries of the battery bank. Extreme climates not only include particularly high temperatures, however, but also particularly low temperatures.

Air conditioning devices for cooling batteries and electronic components for hot regions have become standard in the meanwhile in many charging installations. The possibility for heating the charging station is also frequently ensured. For this purpose, conventional air conditioning devices configured for heating and cooling include a coolant circuit for conducting a coolant to the element to be temperature-controlled and a refrigerant circuit for conducting a refrigerant. Typically, a refrigerant circuit includes a compressor for compressing the refrigerant, a condenser for transferring the refrigerant from a gaseous state into a liquid state, and an expansion valve for expanding the refrigerant, wherein the coolant circuit and the refrigerant circuit are usually configured for bringing the coolant and the refrigerant into thermal contact between the expansion valve and the compressor, in order to control the temperature of the coolant and, therefore, bring the element to be temperature-controlled to a desired temperature or to hold the element to be temperature-controlled at a desired temperature. Provided that the element to be temperature-controlled is to be heated, a heating element arranged at or in the coolant circuit is activated and the refrigerant circuit is deactivated.

The installation of heating elements for cold regions, which is obvious per se, is complex and, therefore, expensive due, among other reasons, to the limited space, in particular, in compact, standardized charging installations, such as, for example, the charge box jointly developed and designed by Dr. Ing. h.c. F. Porsche AG and ads-tec Holding GmbH. In addition, a further variant of the charging installation arising as a result would have to undergo recertification, among other reasons, since the emittance of electromagnetic interference via the air and the coupling of electromagnetic interference into a power supply network could change due to the changed configuration.

### SUMMARY

It is an object of the disclosure to provide a charging station for an electric or hybrid vehicle equipped with an air conditioning device for cooling, the charging station being able to heat a battery bank arranged in the electric or hybrid vehicle at low temperatures without an additional heating element.

This object is, for example, achieved by the charging station for an electric or hybrid vehicle. The charging station includes: at least one battery bank; a charging/discharging electronics system; at least one connection to a vehicle charging port; an air conditioning device for heating and cooling the at least one battery bank, the air conditioning device including a motor, a refrigerant circuit for conducting a refrigerant, and a coolant circuit for conducting a coolant; the refrigerant circuit including a compressor operated by the motor for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state; the coolant circuit including a cold reservoir connected to a heat reservoir via an overflow line; the air conditioning device including at least one first heat exchanger arranged in a space surrounding the battery bank, a first regulatable valve, and a second regulatable valve; the heat reservoir being connectable to the at least one first heat exchanger via the first regulatable valve and the cold reservoir being connectable to the at least one first heat exchanger via the second regulatable valve; and, the air conditioning device having a control unit configured to establish a thermal short circuit of the coolant circuit between the heat reservoir and the cold reservoir and to operate the motor of the compressor for as long as it takes for waste heat of the motor connected to a space surrounding the battery bank to effectuate a temperature increase in the space to or above a predefined value, wherein the space is filled with at least one of a fluidic connection and a convection based connection.

The aforementioned object is, for example, further achieved by a method for operating an air conditioning device of a charging station in a heating mode, the charging station including at least one battery bank, a charging/discharging electronics system, at least one connection to a vehicle charging port, an air conditioning device for heating and cooling the at least one battery bank; the air conditioning device including a motor, a refrigerant circuit for conducting a refrigerant, and a coolant circuit for conducting a coolant; the refrigerant circuit including a compressor operated by the motor for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state; the coolant circuit including a cold reservoir connected to a heat reservoir via an overflow line; the air conditioning device including at least one first heat exchanger arranged in a space surrounding the battery bank, a first regulatable valve, and a second regulatable valve; the heat reservoir being connectable to the at least one first heat exchanger via said first regulatable valve and the cold reservoir being connectable to the at least one first heat exchanger via the second regulatable valve; and, the air conditioning device having a control unit configured to establish a thermal short circuit of the coolant circuit between the heat reservoir and the cold reservoir and to operate the motor of the compressor for as long as it takes for waste heat of the motor connected to a space surrounding the battery bank to effectuate a temperature increase in the space to or above a predefined value, wherein the space is filled with at least one of a fluidic connection and a convection based connection. The method includes: activating the first and second regulatable valves and at least one pump of the coolant circuit such that coolant from the heat reservoir and the cold reservoir of the coolant circuit simultaneously reaches the at least one first heat exchanger and returns to the cold reservoir from the at least one first heat exchanger; operating the motor of the compressor of the refrigerant circuit thermally connected to the cooling circuit; and, measuring a temperature of at least one of the battery bank and the space surrounding the battery bank; and, wherein the heating mode is maintained at least for as long as it takes for the measured temperature to reach or exceed a predefined value.

A charging station according to the disclosure for an electric or hybrid vehicle includes at least one battery bank, a charging/discharging electronics system, at least one connection to a vehicle charging port and an air conditioning device for heating and cooling at least the battery bank.

The air conditioning device includes a refrigerant circuit for conducting a refrigerant and a coolant circuit for conducting a coolant. The coolant circuit includes a cold reservoir connected to a heat reservoir via an overflow line. Moreover, the heat reservoir and the cold reservoir are connectable via regulatable valves to at least one first heat exchanger arranged in a space surrounding the battery bank.

The refrigerant circuit includes a compressor, which is operated by a motor, for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state. The refrigerant is in thermal contact with the coolant in the evaporator in a manner free from intermixing and removes the heat from the coolant coming from the cold reservoir before the coolant returns to the cold reservoir. In the process, the refrigerant cools down further. In the condenser, the refrigerant is also in thermal contact with the coolant in a manner free from intermixing and dissipates heat to the coolant before the coolant, which has been heated in this way, returns to the heat reservoir. Therefore, only heat is exchanged in the condenser and in the evaporator; an exchange of fluids does not take place.

According to the disclosure, a control unit of the air conditioning device is configured for establishing a thermal short circuit of the coolant circuit between the heat reservoir and the cold reservoir and operating the motor of the compressor for as long as it takes for the waste heat of the motor fluidically connected to the space surrounding the battery bank to effectuate a temperature increase in the space to a predefined value. The motor can preferably be operated continuously and/or at high power. The thermal short circuit causes the cold reservoir and the heat reservoir to become fluidically connected and the temperatures of the two reservoirs to approach each other or to not distance themselves from each other to a significant extent due to the operation of the refrigerant circuit, as would be the case in regular operation.

In order to establish the thermal short circuit between the heat reservoir and the cold reservoir, the control unit of the air conditioning device can activate the regulatable valves and at least one pump arranged in the cooling circuit in such a way that a coolant located in the coolant circuit is simultaneously conveyed out of the cold reservoir and the heat reservoir to the at least one first heat exchanger. The temperature in the cold reservoir, into which the coolant coming from the first heat exchanger is conveyed, is not substantially increased as a result, since, in this operating mode, the heat reservoir has not stored an amount of heat that suffices for heating. Provided that the heat reservoir has stored a certain amount of heat, the heat can be initially dissipated, in a heating mode, to the space surrounding the battery bank via the second heat exchanger before the air conditioning device of the charging station is operated in the operating mode according to the disclosure.

The fluidic and/or convection-type connection between the motor and the space surrounding the battery bank can be established, for example, via an air duct or via breakthroughs in the wall of the space surrounding the battery bank to a space in which the motor is arranged. It is also possible to arrange the motor in the space surrounding the battery bank. Preferably, a cooling fan arranged in the space surrounding the battery bank effectuates an air flow in the direction of the motor, so that the power loss of the motor to be dissipated as heat can circulate in the space and heat this space. The cooling fan can also effectuate an air flow in the direction of the first heat exchanger, so that, in a cooling mode, an air flow having warm air is conveyed in the direction of the second heat exchanger. At the same time, in this way, the waste heat of the motor can be removed in an operating mode, in which the cooling circuit is not thermally short circuited.

The method according to the disclosure for controlling an above-described air conditioning device of a charging station for electric and hybrid vehicles in a heating mode according to the disclosure includes switching regulatable and/or controllable valves and activating at least one pump of a cooling circuit, so that coolant from a heat reservoir and from a cold reservoir reach a first heat exchanger arranged in a space surrounding a battery bank at the same time. From the heat reservoir, the coolant then enters the cold reservoir. At the same time, the motor of a compressor of a refrigerant circuit, which is in thermal contact with the coolant circuit via a condenser and an evaporator, is operated and the power loss of the fluidic and/or convection-type connection to the motor connected to the space surrounding the battery bank, which appears in the form of heat, is used for heating the space and, therefore, the battery bank located in the space. In order to achieve a better circulation of the air heated by the motor in the space surrounding the battery bank, a cooling fan arranged in the space can be operated. As soon as the temperature in the battery bank and/or the space surrounding the battery bank, which is measured periodically or continuously at least in the heating mode, has reached or exceeded a predefined value, the charging or discharging of the battery can take place with the maximum charging or discharging power. The thermal short circuit can now be repealed and the air conditioning device can be operated in a normal operating mode again, in order to deliver the waste heat arising in the battery bank and the charging and discharging electronics system to the heat reservoir or to the ambient air via the coolant circuit and the refrigerant circuit.

A control unit of an air conditioning device according to the disclosure includes a microprocessor, a volatile and a non-volatile memory, and sensor inputs and control outputs. The non-volatile memory includes computer program instructions, which, when run by the microprocessor in the volatile memory, configure the control device to carry out the method according to the disclosure and operate the air conditioning device in the heating mode according to the disclosure. The computer program instructions are a standalone computer program product.

The computer program product can be stored on a computer-readable medium or data carrier. The medium or the data carrier can be physically embodied, for example, as a hard drive, a CD, a DVD, a flash memory, or the like, although the medium or the data carrier can also include a modulated electrical, electromagnetic, or optical signal, which can be received by a computer via an appropriate receiver and stored in the memory of the computer.

### BRIEF DESCRIPTION OF DRAWINGS

The invention will now be described with reference to the drawings wherein:

FIG. 1 shows a schematic view of a charging station according to the disclosure for an electric or hybrid vehicle;

FIG. 2 shows a schematic diagram of an air conditioning device, according to the disclosure, of a charging station for an electric or hybrid vehicle; and,

FIG. 3 shows a flow chart of a method for controlling an air conditioning device, according to the disclosure, of a charging station for an electric or hybrid vehicle.

### DETAILED DESCRIPTION

Identical or similar elements can be labeled in the drawing with the same reference characters.

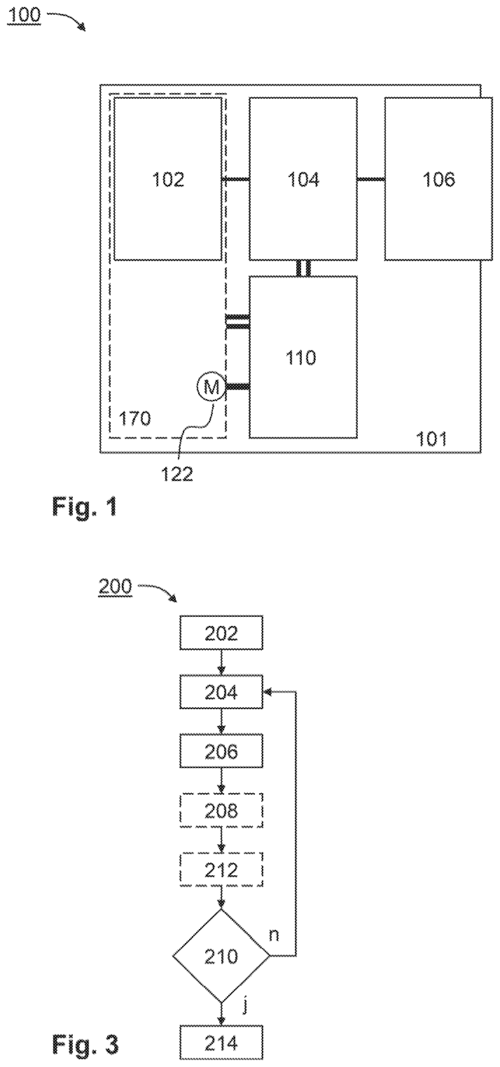

FIG. 1 shows a schematic view of a charging station 100 according to the disclosure for an electric or hybrid vehicle. The charging station 100 includes a housing 101, in which a battery bank 102, a charging/discharging electronics system 104, at least one connection 106 to a vehicle charging port, and an air conditioning device 110 for heating and cooling at least the battery bank 102 are located. The battery bank 102, the charging/discharging electronics system 104, and the at least one connection 106 to a vehicle charging port are electrically connected to one another as indicated by the solid connection lines. The air conditioning device 110 is thermally connected at least to the charging/discharging electronics system 104 and to a space 170, in which the battery bank is arranged. The thermal connection can be configured for heating or cooling in a conventional way. A motor 122, which belongs to the air conditioning device 110 and drives a compressor (not shown in the figure) of the air conditioning device 110, is fluidically connected to the space 170. In the figure, the motor is arranged in the space 170, even though other types of fluidic connections are possible, for example, air ducts, or the like. The motor 122 is preferably arranged underneath the battery bank 102, so that the power loss of the motor 122, which appears in the form of heat and, by convention, rises upward, can heat the battery bank 102 or, if necessary, be dissipated via the thermal connection of the space to the air conditioning device 110.

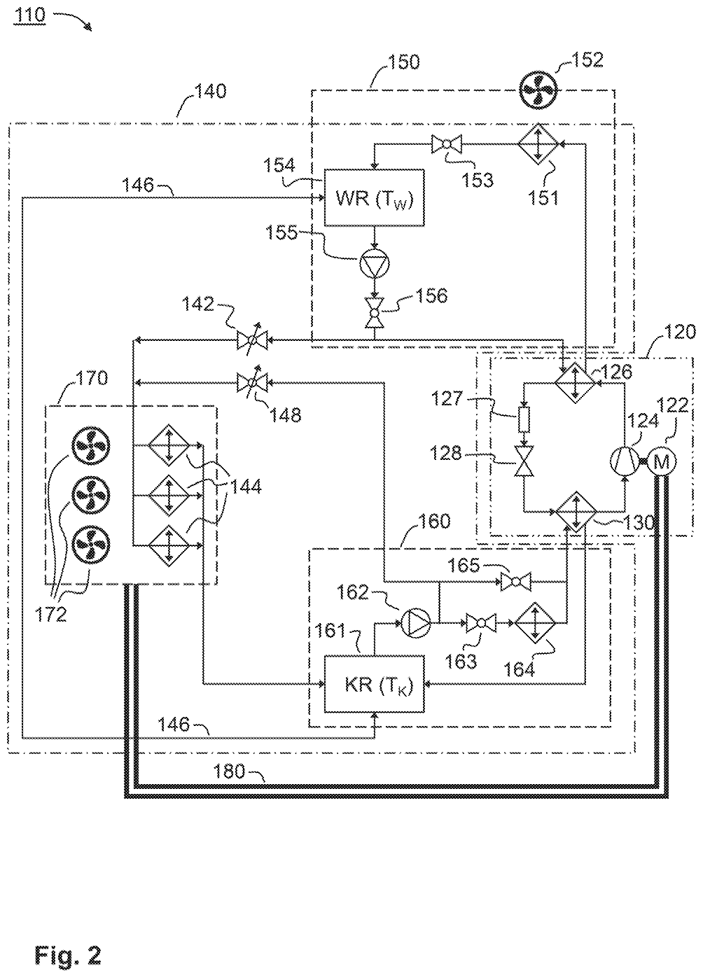

FIG. 2 shows a schematic diagram of an air conditioning device 110, according to the disclosure, of a charging station 100 for an electric or hybrid vehicle. The air conditioning device 110 includes a refrigerant circuit 120 for conducting a refrigerant and a coolant circuit 140 for conducting a coolant. The refrigerant circuit 120 includes a compressor 124 for compressing the refrigerant, which is operated by a motor 122. The refrigerant, which has been heated due to the compression, initially arrives at a condenser 126, which is in heat exchange with a first sub- circuit 150 of the coolant circuit 140, and gives off heat to this first sub-circuit 150. The heat exchange in the condenser 126 takes place due to the refrigerant and the coolant of the coolant circuit 140 passing by each other in a manner free from intermixing. The condensed and cooled refrigerant, coming from the condenser 126, arrives at an expansion valve 128. A collector 127, which receives pressurized condensate, can be arranged upstream from the expansion valve. The expansion valve 128 decompresses and expands the refrigerant, wherein the refrigerant cools down further. The cooled, decompressed refrigerant is guided to an evaporator 130, which is in heat exchange with a second sub-circuit 160 of the coolant circuit 140, and absorbs heat from this second sub-circuit 160. The refrigerant, which is now heated again, is conveyed back to the compressor 124, where the circuit starts over again.

The first sub-circuit 150 of the coolant circuit 140 includes a second heat exchanger 151, which is in heat exchange with the ambient air of a housing of the charging station 100. The coolant heated in the condenser 126 is conveyed through the second heat exchanger 151, where it can dissipate heat to the ambient air. Since the air circulation effectuated by pure convection generally does not suffice, the heat exchange can be improved via one or multiple fan(s) or cooling fan(s) 152, which, as necessary, force(s) an air flow directed toward the second heat exchanger 151. From the second heat exchanger 151, the coolant is conveyed via a shut-off valve 153 to a heat reservoir 154, in which the coolant, which is still heated, can collect. From the heat reservoir 154, the coolant is guided back to the condenser 126 via a pump 155 and a shut-off valve 156. The coolant can circulate in this first sub-circuit 150. Alternatively, a portion of the coolant from the first sub-circuit 150 can be conveyed via a regulatable valve 142 to a first heat exchanger 144, which is in heat exchange with a space 170 surrounding a battery bank, in order to heat the space 170 surrounding the battery bank 102. The heat exchange can be improved via one or multiple fan(s) or cooling fan(s) 172, which, as necessary, force(s) an air flow passing along the first heat exchanger 144.

From the first heat exchanger 144, the coolant arrives at a cold reservoir 161 of the second sub-circuit 160 of the coolant circuit 140. From the cold reservoir 161, the coolant is conveyed via a pump 162 and via a shut-off valve 163 to a third heat exchanger 164, which is in heat exchange with electronic components of the charging station 100, in order to cool the charging station 100 as necessary. From the third heat exchanger 164, the heated coolant is conveyed via the evaporator 130, where it dissipates heat to the refrigerant of the refrigerant circuit. A bypass valve 165 bridges, optionally, the shut-off valve 163 and the third heat exchanger 164. A further line extends from the pump 162 to a regulatable valve 148, so that the first heat exchanger 144 can be optionally acted upon by cold coolant from the cold reservoir, in order to cool the space 170 surrounding the battery bank 102. The cold reservoir 161 is also fluidically connected to the heat reservoir 154 via an overflow line 146.

At very low ambient temperatures and, in particular, when the charging station 100 has not been used for a period of multiple hours, the heat reservoir 154 can be cooled down, because the electronic components have not generated any heat, which would need to be dissipated via the third heat exchanger 164. Therefore, it is no longer possible to heat the space 170 surrounding the battery bank 102 via the heat stored in the heat reservoir 154. The temperature of the battery bank 102 can therefore be outside an optimal operating temperature range, in which the greatest possible power can be produced. Since a separate heating element is not provided for the space 170 surrounding the battery bank 102, the required heat must be generated in another way.

According to the disclosure, the motor 122 driving the compressor 124 is connected to the space 170 surrounding the battery bank 102 via a fluidic and/or convection-type connection. This connection can be achieved via an air duct 180, via which air from the space 170 is guided past the motor 122 and, in this way, heats up, or simply due to the fact that the motor 122 is arranged in the space 170 and the air contained in the space 170 flows around the motor 122. The motor can give off a power loss in the form of heat in a magnitude of multiple kW. Since the space 170 is only a few cubic meters in size, the air in the space can be quickly heated up at full performance of the motor. The heated air therefore also heats up the battery bank 102 arranged in the space 170.

Since the motor 122 is controlled by a temperature control system, however, which is primarily intended to effectuate a cooling of electronic components and the battery bank 102, but a further cooling is not desired at this moment, a special heating mode is necessary according to the disclosure.

In this special heating mode, the pumps 155 and 162 deliver coolant from the heat reservoir 154 and the cold reservoir 161 at the same time via the simultaneously open regulatable valves 142 and 148 to the first heat exchanger 144, which is arranged in the space 170 surrounding the battery bank 102. Since no power is output to a vehicle to be charged, that is, the electronic components do not generate any heat, this branch of the second sub-circuit 160 of the coolant circuit 140 is blocked via a shut-off valve 163 and short-circuited via a bypass valve 165. A mixture of cold and still-warm coolant now flows to the first heat exchanger 144, the mixture not sufficing for an effective heating of the space 170. From the first heat exchanger 144, the coolant enters the cold reservoir 161. In this way, the coolant circuit 140 is quasi operated in a thermal short circuit.

The controller of the air conditioning device will now attempt to establish a temperature difference between the cold reservoir 161 and the heat reservoir 154 and, for this purpose, will operate the refrigerant circuit 120 at full power. Primarily, this means that the motor 122 is continuously operated and its power loss is dissipated to the air circulating in the space 170. Cooling fans 172 arranged in the space 170, which generate an air flow directed toward the first heat exchanger 144, can improve the circulation of the air heated by the waste heat of the motor 122, so that all areas of the space 170 and the battery bank 102 arranged in the space 170 heat up. The cooling fan 152, which, in normal operation, is intended to dissipate excess heat from the first sub-circuit 150 of the coolant circuit 140 to the ambient air of the charging station 100, is preferably not operated during this time, so that the cooling of the coolant in the first sub-circuit 150 of the coolant circuit 140 is kept low.

As soon as the battery bank 102 has reached a temperature at which a sufficient charging and discharging power can be produced, the thermal short circuit of the coolant circuit 120 is repealed again. The pumps 155 and 162 are alternatively operated again as necessary and the regulatable valves 142 and 148 are alternatively opened as necessary. The bypass valve 165 is closed and the waste heat generated in the electronic components during charging and discharging is dissipated via the third heat exchanger 164, which is connected to the second sub- circuit 160 of the coolant circuit 140 via the shut-off valve 163, which is now open again. Provided that the temperature in the space 170 is not yet high enough, the cooling fan 152 can remain out of operation, so that the heat reservoir 154 can reach a temperature that is sufficiently high for the further heating of the space 170.

FIG. 3 shows a flow diagram of a method 200 for controlling an air conditioning device 110, according to the disclosure, of a charging station 100 for an electric or hybrid vehicle in a heating mode. In the step 202, controllable or regulatable valves 142, 148 and at least one of the pumps 155, 162 of the coolant circuit 140 are activated in such a way that coolant from a heat reservoir 154 and a cold reservoir 161 of the coolant circuit 140 simultaneously reaches a first heat exchanger 144 arranged in a space 170 surrounding a battery bank 102 and returns to the cold reservoir 161 from the first heat exchanger 144. In addition, in the step 204, a motor 122 of a compressor 124 of a refrigerant circuit 120 thermally connected to the coolant circuit 140 is operated, the motor 122 being fluidically connected to the space 170 surrounding the battery bank 102. In the step 206, the temperature of the battery bank 102 and/or the space 170 surrounding the battery bank 102 is cyclically or continuously measured. This heating mode is maintained at least for as long as it takes for the measured temperature to reach or exceed a predefined value. An appropriate check is carried out in step 210. A cooling fan 172 arranged in the space 170 surrounding the battery bank 102 can be operated in parallel to the check, in order to generate an air flow in the space 170, step 208. In addition, in step 212, a signal routed to a charging or discharging electronics system is generated, the signal representing the measured temperature or the attainment or exceedance of the predefined temperature value. When the measured temperature has reached or exceeded a predefined value, a charging or discharging power of the charging station that is as great as possible can be released. Since power losses occur due to the charging and discharging of the battery bank 102, the power losses appearing in the form of heat in the battery bank 102 itself and in the charging/discharging electronics system, which power losses must be dissipated, the air conditioning device can now be operated again in a conventional cooling or heating mode, and the thermal short circuit of the coolant circuit can be repealed, step 214.

It is understood that the foregoing description is that of the preferred embodiments of the invention and that various changes and modifications may be made thereto without departing from the spirit and scope of the invention as defined in the appended claims.

1. A charging station for an electric or hybrid vehicle, the charging station comprising:
at least one battery bank;
a charging/discharging electronics system;
at least one connection to a vehicle charging port;
an air conditioning device for heating and cooling said at least one battery bank, said air conditioning device including a motor, a refrigerant circuit for conducting a refrigerant, and a coolant circuit for conducting a coolant;
said refrigerant circuit including a compressor operated by said motor for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state;
said coolant circuit including a cold reservoir connected to a heat reservoir via an overflow line;
said air conditioning device including at least one first heat exchanger arranged in a space surrounding said battery bank, a first regulatable valve, and a second regulatable valve;
said heat reservoir being connectable to said at least one first heat exchanger via said first regulatable valve and said cold reservoir being connectable to said at least one first heat exchanger via said second regulatable valve; and,
said air conditioning device having a control unit configured to establish a thermal short circuit of said coolant circuit between said heat reservoir and said cold reservoir and to operate said motor of the compressor for as long as it takes for waste heat of said motor connected to a space surrounding the battery bank to effectuate a temperature increase in the space to or above a predefined value, wherein the space is filled with at least one of a fluidic connection and a convection based connection.

2. The charging station of claim 1, wherein said coolant circuit includes at least one pump; and, said control unit is configured to activate said first regulatable valve, said second regulatable valve, and said at least one pump arranged in the coolant circuit such that a coolant located in said coolant circuit is simultaneously conveyed out of said cold reservoir and said heat reservoir to said at least one first heat exchanger to establish the thermal short circuit between said heat reservoir and said cold reservoir.

3. The charging station of claim 1 further comprising a cooling fan arranged in the space surrounding the battery bank; and, said cooling fan being configured to effectuate an air flow in a direction of the motor, where air absorbs heat of said motor and conveys the heat of said motor into the space surrounding said battery bank.

4. A method for operating an air conditioning device of a charging station in a heating mode, the charging station including at least one battery bank, a charging/discharging electronics system, at least one connection to a vehicle charging port, an air conditioning device for heating and cooling the at least one battery bank; the air conditioning device including a motor, a refrigerant circuit for conducting a refrigerant, and a coolant circuit for conducting a coolant; the refrigerant circuit including a compressor operated by the motor for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state; the coolant circuit including a cold reservoir connected to a heat reservoir via an overflow line; the air conditioning device including at least one first heat exchanger arranged in a space surrounding the battery bank, a first regulatable valve, and a second regulatable valve; the heat reservoir being connectable to the at least one first heat exchanger via said first regulatable valve and the cold reservoir being connectable to the at least one first heat exchanger via the second regulatable valve; and, the air conditioning device having a control unit configured to establish a thermal short circuit of the coolant circuit between the heat reservoir and the cold reservoir and to operate the motor of the compressor for as long as it takes for waste heat of the motor connected to a space surrounding the battery bank to effectuate a temperature increase in the space to or above a predefined value, wherein the space is filled with at least one of a fluidic connection and a convection based connection; the method comprising:
activating the first and second regulatable valves and at least one pump of the coolant circuit such that coolant from the heat reservoir and the cold reservoir of the coolant circuit simultaneously reaches the at least one first heat exchanger and returns to the cold reservoir from the at least one first heat exchanger;
operating the motor of the compressor of the refrigerant circuit thermally connected to the cooling circuit; and,
measuring a temperature of at least one of the battery bank and the space surrounding the battery bank; and,
wherein the heating mode is maintained at least for as long as it takes for the measured temperature to reach or exceed a predefined value.

5. The method of claim 4 further comprising operating a cooling fan arranged in the space surrounding the battery bank in order to generate an air flow in the space.

6. The method of claim 4 further comprising generating a signal routed to the charging or discharging electronics system, the signal representing the measured temperature or attainment or exceedance of the predefined temperature value.

7. The method of claim 5 further comprising generating a signal routed to the charging or discharging electronics system, the signal representing the measured temperature or attainment or exceedance of the predefined temperature value.

8. A computer program product for operating an air conditioning device of a charging station, the charging station including a control unit, at least one battery bank, a charging/discharging electronics system, at least one connection to a vehicle charging port, and an air conditioning device, the air conditioning device being for heating and cooling the at least one battery bank, the air conditioning device including a motor, a refrigerant circuit for conducting a refrigerant, and a coolant circuit for conducting a coolant, the refrigerant circuit including a compressor operated by the motor for compressing the refrigerant, a condenser for transferring the refrigerant from a gaseous state into a liquid state, an expansion valve for expanding and decompressing the refrigerant, and an evaporator for transferring the refrigerant from a liquid state into a gaseous state; the coolant circuit including a cold reservoir connected to a heat reservoir via an overflow line; the air conditioning device including at least one first heat exchanger arranged in a space surrounding said battery bank, a first regulatable valve, and a second regulatable valve; the heat reservoir being connectable to the at least one first heat exchanger via the first regulatable valve and the cold reservoir being connectable to the at least one first heat exchanger via the second regulatable valve; the air conditioning device including the control unit and the control unit being configured to establish a thermal short circuit of said coolant circuit between said heat reservoir and said cold reservoir and operating said motor of the compressor for as long as it takes for waste heat of said motor connected to a space surrounding the battery bank to effectuate a temperature increase in the space to or above a predefined value, wherein the space is filled with at least one of a fluidic connection and a convection based connection, the computer program comprising:
a computer program code configured, when executed by a processor of the control unit, to:
activate the first and second regulatable valves and at least one pump of the coolant circuit such that coolant from the at least one heat reservoir and the cold reservoir of the coolant circuit simultaneously reaches the first heat exchanger and returns to the cold reservoir from the at least one first heat exchanger;
operate the motor of the compressor of the refrigerant circuit thermally connected to the cooling circuit;
measure a temperature of at least one of the battery bank and the space surrounding the battery bank;
wherein the heating mode is maintained at least for as long as it takes for the measured temperature to reach or exceed a predefined value; and,
operate a cooling fan arranged in the space surrounding the battery bank in order to generate an air flow in the space.

9. The computer program product of claim 8, wherein the computer program code is further configured, when executed by the processor, to generate a signal routed to the charging or discharging electronics system, the signal representing the measured temperature or attainment or exceedance of the predefined temperature value.
